(19) United States
(12) Patent Application Publication
(10) Pub. No.: US 2018/0332291 A1
(43) Pub. Date: Nov. 15, 2018

(54) INFORMATION PROCESSING SYSTEM AND INFORMATION PROCESSING METHOD

(71) Applicant: CANON KABUSHIKI KAISHA, Tokyo (JP)

(72) Inventor: Takayuki Komine, Kawasaki-shi (JP)

(21) Appl. No.: 15/973,805

(22) Filed: May 8, 2018

(30) Foreign Application Priority Data
May 11, 2017 (JP) 2017-094856

(51) Int. Cl. H04N 19/15; H04N 5/247; H04N 19/115

(52) U.S. Cl. CPC H04N 19/15; H04N 19/115; H04N 5/247

(57) ABSTRACT

A transmission device that transmits data via a network is configured to adjust an amount of data to be transmitted to be equal to or less than a threshold by decreasing a quality of an image, when the amount of data to be transmitted exceeds the threshold, the data to be transmitted including the image, and transmit data for improving the quality of the image via the network after the data to be transmitted is transmitted, the data amount of the data to be transmitted being adjusted.

### BACKGROUND

### Field of the Disclosure

The present disclosure relates to an information processing system and an information processing method.

### Description of the Related Art

A technique is known in which image capturing is simultaneously performed by a plurality of cameras installed at different locations and a virtual viewpoint content is generated using images captured from a plurality of viewpoints obtained by the image capturing. According to this technique, for example, highlight scenes in football or basketball games can be viewed from various angles, which makes it possible to provide users with higher realistic sensation than in normal images.

Meanwhile, in the case of generating and browsing a virtual viewpoint content based on images captured from a plurality of viewpoints, images captured by a plurality of cameras are first aggregated in an image processing unit such as a server. Next, the image processing unit generates a three-dimensional model using the images captured by the plurality of cameras and performs processing, such as rendering, thereby generating the virtual viewpoint content to be transmitted to a user terminal.

The specification of U.S. Pat. No. 7,106,361 discusses a technique for aggregating images captured by a plurality of cameras. The specification of U.S. Pat. No. 7,106,361 discusses the following technique. That is, a plurality of cameras is connected with an optical fiber through control units paired with the cameras. Each control unit accumulates image frames captured by the cameras paired with the control units. The image generation unit outputs an image representing continuous motion using the image frames accumulated in each control unit.

### SUMMARY

A transmission device according to one or more aspects of the present disclosure is configured to adjust an amount of data to be transmitted to be equal to or less than a threshold by decreasing a quality of an image, when the amount of data to be transmitted exceeds the threshold, the data to be transmitted including the image, and transmit data for improving the quality of the image via a network after the data to be transmitted is transmitted, the amount of the data to be transmitted being adjusted.

Further features of the present disclosure will become apparent from the following description of exemplary embodiments (with reference to the attached drawings).

### BRIEF DESCRIPTION OF THE DRAWINGS

FIG. 1 is a diagram illustrating a configuration of an image processing system according to one or more aspects of the present disclosure.

FIG. 2 is a diagram illustrating a configuration of a camera adapter according to one or more aspects of the present disclosure.

FIG. 3 is a diagram illustrating an installation example of the image processing system according to one or more aspects of the present disclosure.

FIG. 4 is a diagram illustrating a flow of data among camera adapters according to one or more aspects of the present disclosure.

FIG. 5 is a flowchart illustrating processing of a data selection processing unit according to one or more aspects of the present disclosure.

FIG. 6 is a graph illustrating a first example of a time change of a data amount.

FIG. 7 is a diagram illustrating a first example of a change of data to be transmitted to a database.

FIG. 8 is a diagram illustrating a second example of a change of data to be transmitted to the database.

FIG. 9 is a flowchart illustrating processing of step S5015 illustrated in FIG. 5.

FIG. 10 is a graph illustrating a second example of a time change of a data amount.

### DESCRIPTION OF THE EMBODIMENTS

To generate a virtual viewpoint content, images of an object captured by a plurality of cameras are required. Accordingly, if the number of objects which are subjects to be imaged increases, a transmission load on a network may increase depending on the number of objects. Therefore, in the case of transmitting data, such as images captured by each camera, a communication band may become insufficient depending on the status of the system, which may make it difficult to transmit data necessary for generating the virtual viewpoint content.

According to exemplary embodiments described below, the communication band for transmitting captured images is prevented from being insufficient.

Exemplary embodiments will be described in detail below with reference to the drawings.

### First Exemplary Embodiment

First, a first exemplary embodiment will be described.

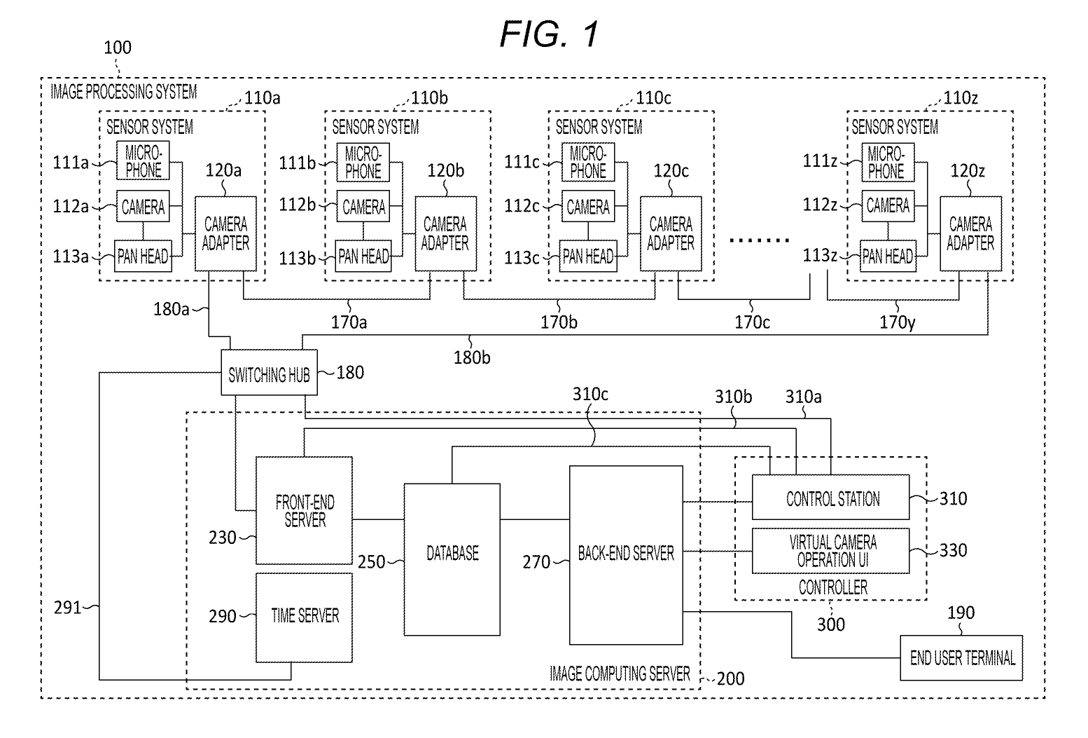

FIG. 1 is a diagram illustrating an example of the configuration of an image processing system 100. The present exemplary embodiment illustrates an example in which a plurality of cameras and a plurality of microphones are installed in facilities, such as a stadium or a concert hall. The image processing system 100 captures images using a plurality of cameras and collects sound using a plurality of microphones. The image processing system 100 includes sensor systems 110a to 110z, an image computing server 200, a controller 300, a switching hub 180, and an end user terminal 190. In the present exemplary embodiment, an example of the information processing system is implemented by, for example, the image processing system 100.

The controller 300 includes a control station 310 and a virtual camera operation UI 330. The control station 310 performs management of an operation state, setting of parameters, and the like via networks 310a to 310c, 180a, 180b, and 170a to 170y on each of the blocks constituting the image processing system 100. In this case, each network may be a local area network, or a combination of an interconnect (Infiniband etc.). The networks are not limited to these examples, but instead other types of networks may be used.

An example of an operation for transmitting images and audio obtained by 26 sets of the sensor systems 110a to 110z from the sensor system 110z to the image computing server 200 will be described first. The present exemplary embodiment illustrates an example in which the sensor systems 110a to 110z are connected to each other with a daisy chain.

In the present exemplary embodiment, unless otherwise stated, the 26 sets of sensor systems 110a to 110z are collectively referred to as a sensor system 110. The devices and networks in each sensor system 110 are also collectively referred to as a microphone 111, a camera 112, a pan head 113, a camera adapter 120, and a network 170, unless otherwise stated.

In the present exemplary embodiment, the 26 sets of sensor systems 110 are provided by way of example. The number of sensor systems 110 is not limited to 26 sets. In the present exemplary embodiment, unless otherwise specified, the description is made assuming that images include moving images and still images. In other words, the image processing system 100 according to the present exemplary embodiment can perform processing on still images and moving image. In the present exemplary embodiment, an example where a virtual viewpoint content provided by the image processing system 100 includes a virtual viewpoint image and virtual viewpoint audio is mainly described. However, the virtual viewpoint content is not limited to this example. For example, the virtual viewpoint content may include no audio. For example, audio included in the virtual viewpoint content may be audio collected by a microphone located at a position closest to the virtual viewpoint. In the present exemplary embodiment, detailed descriptions of audio are partially omitted for simplification of explanation, assuming that audio is basically processed with images.

The sensor systems 110a to 110z include cameras 112a to 112z, respectively. Specifically, the image processing system 100 includes a plurality of cameras for capturing images of a subject from a plurality of directions. The sensor systems 110 are connected to each other with a daisy chain.

The connection form of the plurality of sensor systems 110 is not limited to the daisy chain. For example, a star network may be used. In the case of using a start network, all the sensor systems 110a to 110z are connected to the switching hub 180. In this case, data transmission and reception between the sensor systems 110a to 110z is performed via the switching hub 180.

FIG. 1 illustrates a configuration in which all the sensor systems 110a to 110z are connected in cascade so as to establish a daisy chain connection. However, there is no need for all the sensor systems 110a to 110z to be connected in cascade. For example, the plurality of sensor systems 110 may be divided into a plurality of groups. In this case, the sensor systems 110 may be connected so as to establish a daisy chain connection for each divided group. The camera adapter 120 located at an end in each divided group may be connected to the switching hub 180 and the switching hub 180 may output images captured by each camera 112 to the image computing server 200. This configuration is especially effective when the image processing system 100 is applied to a stadium. For example, assume a case where the stadium includes a plurality of floors and the sensor system 110 is equipped in each floor. When the configuration described above is employed in such a case, images captured by the camera 112 can be input to the image computing server 200, for example, for each floor or every half cycle of the stadium. Therefore, it is possible to facilitate the installation of the sensor system 110 and make the system flexible even in a location where it is difficult to install wiring for connecting all the sensor systems 110 with one daisy chain.

The control for image processing in the image computing server 200 is switched depending on whether the number of the camera adapters 120 to be connected with a daisy chain to output images to the image computing server 200 is one or two or more. In other words, the control for image processing in the image computing server 200 is switched depending on whether the sensor system 110 is divided into a plurality of groups. When the number of the camera adapters 120 that output images to the image computing server 200 is one, the images are transmitted between the sensor systems 110, which are connected with a daisy chain, and the images are transmitted from the camera adapter 120 located at an end to the image computing server 200. The image computing server 200 generates an image of the perimeter of the stadium. Accordingly, timings for obtaining image data on the perimeter of the stadium are synchronized in the image computing server 200. In other words, unless the sensor system 110 is divided into groups, the timings for obtaining necessary image data can be synchronized in the image computing server 200.

On the other hand, when a plurality of camera adapters 120 outputs images to the image computing server 200 (when the sensor system 110 is divided into groups), a delay in the image data during transmission varies depending on the lane (path) of each daisy chain. Accordingly, the image computing server 200 needs to perform image processing at a subsequent stage while checking the assembly of image data by synchronizing the image data until all the image data on the perimeter of the stadium are received.

In the present exemplary embodiment, the sensor system 110a includes a microphone 111a, a camera 112a, a pan head 113a, and a camera adapter 120a. The configuration of the sensor system 110a is not limited to this configuration. The sensor system 110a may include at least one camera adapter 120a and at least one camera 112a. For example, the sensor system 110a may include one camera adapter 120a and a plurality of cameras 112a, or may include one camera 112a and a plurality of camera adapters 120a. In other words, at least one camera 112 and at least one camera adapter 120 in the image processing system 100 correspond to N:M (N and M represent an integer equal to or greater than 1). The sensor system 110 may include devices other than the microphone 111a, the camera 112a, the pan head 113a, and the camera adapter 120a. The camera 112a and the camera adapter 120a may be integrally formed. Further, a front-end server 230 may include at least some of the functions of the camera adapter 120a. In the present exemplary embodiment, the configuration of the sensor systems 110b to 110z is the same as the configuration of the sensor system 110a, and thus detailed descriptions of the sensor systems 110b to 110z are omitted. The configuration of each of the sensor systems 110b to 110z are not limited to the same configuration of the sensor system 110a. The sensor systems 110 may have different configurations.

Images captured by the camera 112a are subjected to image processing, which is described below, in the camera adapter 120a, and are then transmitted to a camera adapter 120b of the sensor system 110b through the network 170a. Audio collected by the microphone 111a is also transmitted to the camera adapter 120b of the sensor system 110b through the network 170a. The sensor system 110b transmits the audio collected by the microphone 111b and the images captured by a camera 112b to the sensor system 110c together with the images and audio acquired from the sensor system 110a.

The above-described operation is also continued in the sensor systems 110c to 110z. As a result, the images and audio acquired by the sensor systems 110a to 110z are transmitted to the switching hub 180 from the sensor system 110z through the network 180b and are transmitted from the switching hub 180 to the image computing server 200.

In the present exemplary embodiment, the configuration in which the cameras 112a to 112z and the camera adapters 120a to 120z are separated from each other is illustrated by way of example. However, the cameras 112a to 112z and the camera adapters 120a to 120z may be integrally formed in the identical housing. In this case, the microphones 111a to 111z may be incorporated in the cameras 112a to 112z that are formed integrally with the camera adapters 120a to 120z, or may be connected to the outside of the cameras 112a to 112z.

Next, an example of the configuration and operation of the image computing server 200 will be described. The image computing server 200 according to the present exemplary embodiment processes data acquired from the sensor system 110z. The image computing server 200 includes a front-end server 230, a database 250, a back-end server 270, and a time server 290.

The time server 290 has a function of delivering a time and a synchronization signal. The time server 290 delivers the time and synchronization signal to each of the sensor systems 110a to 110z via the switching hub 180. The camera adapters 120a to 120z which have received the time and the synchronization signal cause the image data obtained by the cameras 112a to 112z to be genlocked based on the time and the synchronization signal, thereby performing frame synchronization of the image data. Specifically, the time server 290 synchronizes the image capturing timings of the plurality of cameras 112a to 112z. The image processing system 100 adds information, such as a time code, to the image data obtained by the plurality of cameras 112a to 112z, a virtual viewpoint image can be generated based on the plurality of images captured at the same timing. Accordingly, it is possible to prevent a degradation of the quality of the virtual viewpoint image due to a deviation in the image capturing timing. Assume that, in the present exemplary embodiment, the time server 290 manages the time synchronization of the plurality of cameras 112. However, the time server 290 need not necessarily manage the time synchronization of the plurality of cameras 112. For example, the processing for time synchronization may be performed independently by each camera 112 or each camera adapter 120.

The front-end server 230 converts a data format by reconfiguring segmented transmission packets from the image data and audio data acquired from the sensor system 110z. The front-end server 230 writes, into the database 250, the image data and audio data whose data format has been converted in such a manner that the image data and audio data are associated with the identifier of each camera, a data type, a frame number, and the like.

The database 250 manages, using a state management table, the image data (frames) from each sensor system 110 and the reception status of the image data which are acquired from the sensor system 110z. For example, an information management table stores flags for each time and each camera 112. For each time and each camera 112, the front-end server 230 sets a flag indicating “0” when the image data has not been delivered, and sets a flag indicating “1” when the image data has been delivered. The information management table may store flags for each predetermined time (e.g., one second) and each camera 112. In this case, the front-end server 230 sets the flag indicating “1” when all image data from the camera 112 have been received at every predetermined time, and sets the flag indicating “0” when not all image data have not received.

The back-end server 270 accepts the designation of the virtual viewpoint from the virtual camera operation UI 330. The back-end server 270 reads, from the database 250, the image data and audio data corresponding to the viewpoint received from the virtual camera operation UI 330 based on the viewpoint received from the virtual camera operation UI 330. The back-end server 270 performs rendering processing on the image data and audio data read from the database 250 and generates a virtual viewpoint image. In this case, the database 250 provides the image data and audio data to the back-end server 270 according to the reception status stored in the state management table in response to a read request from the back-end server 270.

The virtual viewpoint image and virtual viewpoint audio which are subjected to rendering processing are transmitted from the back-end server 270 to the end user terminal 190. A user who operates the end user terminal 190 can browse the images and listen to the audio according to the designated viewpoint. Specifically, the back-end server 270 generates a virtual viewpoint content based on images (a plurality of virtual viewpoint images) captured by the plurality of cameras 112 and virtual viewpoint information.

The virtual viewpoint content according to the present exemplary embodiment is a content including virtual viewpoint images as images obtained by capturing images of a subject from virtual viewpoints. In other words, it can also be said that virtual viewpoint images are images representing a view from the viewpoint designated by the virtual camera operation UI 330. The viewpoint may be designated by the user, or may be automatically designated based on, for example, the result of an image analysis.

The back-end server 270 may transmit the virtual viewpoint image to the end user terminal 190 by using a MPEG-DASH protocol after encoding the virtual viewpoint image by standard techniques as typified by H.264 or HEVC.

Thus, the image processing system 100 includes three function domains, i.e., a video collection domain, a data storage domain, and a video generation domain. The video collection domain includes the sensor systems 110a to 110z. The data storage domain includes the database 250, the front-end server 230, and the back-end server 270. The video generation domain includes the virtual camera operation UI 330 and the end user terminal 190. The configuration of the image processing system 100 is not limited to the configuration described above. For example, the virtual camera operation UI 330 can directly acquire image data from the sensor systems 110a to 110z. However, in the present exemplary embodiment, instead of employing the method of directly acquiring image data from the sensor systems 110a to 110z, the data storage domain is disposed between the video collection domain and the video generation domain. Specifically, the front-end server 230 converts the image data and audio data, which are generated by the sensor systems 110a to 110z, and meta information about the data, into a common schema and data form of the database 250.

In the present exemplary embodiment, the virtual camera operation UI 330 accesses the database 250 through the back-end server 270, instead of directly accessing the database 250. The back-end server 270 performs common processing associated with image generation processing, and the virtual camera operation UI 330 performs processing on a difference portion of an application associated with the operation UI. Accordingly, in the case of developing the virtual camera operation UI 330, it is possible to focus on the development of an operation device serving as a user interface (UI) and functions of the UI for operating virtual viewpoint images to be generated. The back-end server 270 can also add or delete common processing associated with image generation processing in response to a request from the virtual camera operation UI 330. This makes it possible to flexibly cope with the request from the virtual camera operation UI 330.

In this manner, in the image processing system 100, the back-end server 270 generates virtual viewpoint images based on the image data obtained by the plurality of cameras 112 for capturing images of a subject from a plurality of directions. The image processing system 100 according to the present exemplary embodiment is not limited to the physical configuration described above, but instead may be logically configured. The image processing system 100 may be configured using a plurality of devices, or may be configured using one device.

In the present exemplary embodiment, for example, an example of a plurality of information processing apparatuses is implemented using the camera adapters 120a to 120z. The virtual camera operation UI 330 sets a viewpoint for a subject. The back-end server 270 generates an image of the subject as viewed from the viewpoint set by the virtual camera operation UI 330 by using an image of a region of the subject included in the plurality of images captured from a plurality of directions.

(Camera Adapter)

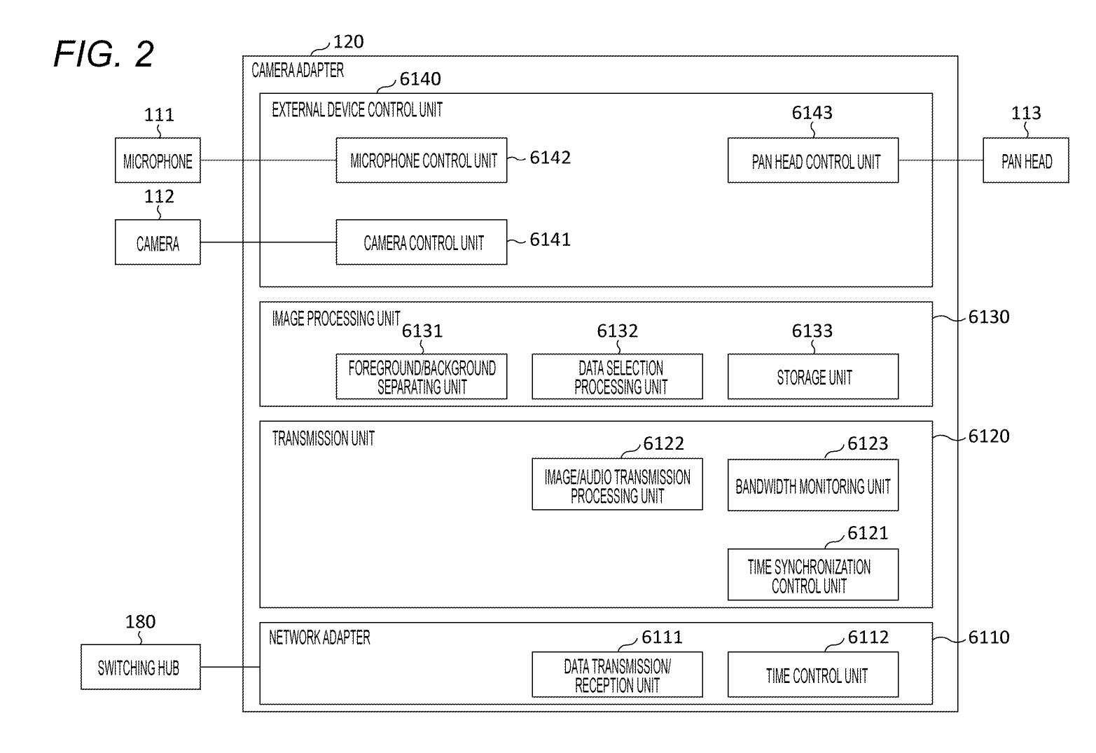

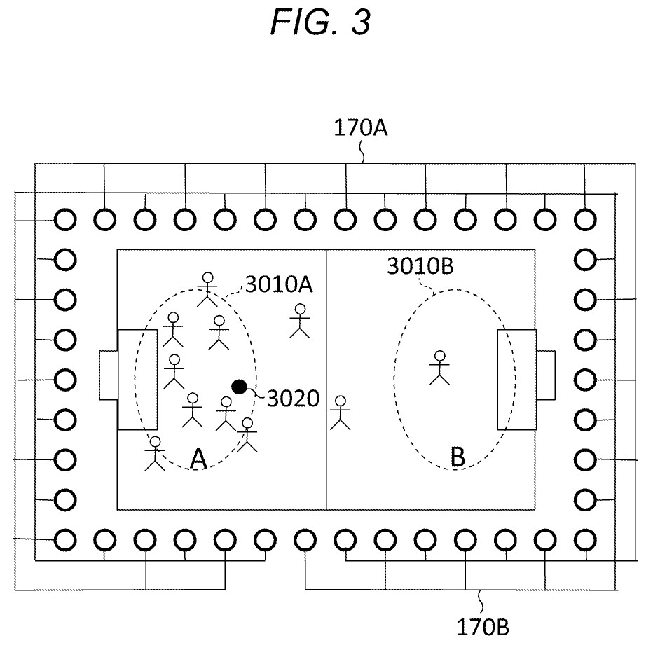

Next, an example of functional blocks of the camera adapter 120 according to the present exemplary embodiment will be described with reference to FIG. 2. FIG. 2 is a diagram illustrating an example of the functional configuration of the camera adapter 120. Details of the flow of data among the functional blocks of the camera adapter 120 will be described below with reference to FIG. 3.

The camera adapter 120 includes a network adapter 6110, a transmission unit 6120, an image processing unit 6130, and an external device control unit 6140.

The network adapter 6110 includes a data transmission/reception unit 6111 and a time control unit 6112.

The data transmission/reception unit 6111 performs data communication with the other camera adapter 120, the front-end server 230, the time server 290, and the control station 310 via the networks 170, 291, and 310a. For example, the data transmission/reception unit 6111 outputs, to another camera adapter 120, a foreground image and a background image which are separated by a foreground/background separating unit 6131 from the image captured by the camera 112. The camera adapter 120 to which the foreground image and the background image are output is the camera adapter 120 subsequent to the camera adapter 120 in a predetermined order among the camera adapters 120 in the image processing system 100. Each camera adapter 120 outputs the foreground image and the background image, thereby generating a virtual viewpoint image based on the foreground image and the background image that are captured from a plurality of viewpoints. Some of the camera adapters 120 may output the foreground image separated from the captured image and may not output the background image. The foreground image and the background image may be separated in the image computing server 200.

The time control unit 6112 has a function of storing a time stamp of data transmitted to and received from the time server 290 based on, for example, Ordinary Clock in IEEE1588 standards, and a function of performing time synchronization with the time server 290. A protocol for time synchronization is not limited to IEEE1588, but instead may be, for example, other EtherAVB standards or unique protocols. In the present exemplary embodiment, a Network Interface Card (NIC) is used as the network adapter 6110. However, the network adapter 6110 is not limited to the NIC and other interfaces may be used. IEEE1588 is updated as standards like IEEE1588-2002 and IEEE1588-2008. The latter standards are also referred to as Precision Time Protocol Version 2 (PTPv2).

The transmission unit 6120 has a function of controlling the transmission of data to the switching hub 180 and the like through the network adapter 6110, and includes the following functional units.

A time synchronization control unit 6121 has a function of performing processing associated with the time synchronization with the time server 290 based on Precision Time Protocol (PTP) of IEEE1588 standards. A protocol for performing the time synchronization is not limited to the PTP and other similar protocols may be used to perform the time synchronization.

An image/audio transmission processing unit 6122 has a function of creating a message for transferring image data and audio data to another camera adapter 120 or the front-end server 230 through the data transmission/reception unit 6111. The message includes the image data and audio data and meta information about the data. The meta information according to the present exemplary embodiment includes a time code or sequence number obtained when an image is captured and when audio is sampled, data type, and an identifier indicating the individual piece of each of the camera 112 and the microphone 111. The image/audio transmission processing unit 6122 receives the message from another camera adapter 120 through the data transmission/reception unit 6111. Further, the image/audio transmission processing unit 6122 restores the data information fragmented into a packet size defined in a transmission protocol into image data and audio data according to the type of data included in the message received from another camera adapter 120.

A bandwidth monitoring unit 6123 monitors the amount of data transmitted from the network 170 connected at an upstream side of the camera adapter 120 to which the bandwidth monitoring unit 6123 belongs, and notifies the image processing unit 6130, which is described below, of the monitoring result.

The image processing unit 6130 has a function of performing processing on the image data obtained by the camera 112 controlled by a camera control unit 6141, and includes the following functional units.

The foreground/background separating unit 6131 has a function of separating image data obtained by the camera 112 into a foreground image and a background image. Specifically, the foreground/background separating unit 6131 extracts a predetermined region from the image data obtained by the camera 112 corresponding to the camera adapter 120 to which the foreground/background separating unit 6131 belongs. The predetermined region is a region of the foreground image obtained as a result of detecting, for example, an object for the captured image. The foreground/background separating unit 6131 separates the captured image into a foreground image and a background image based on the result of extracting the predetermined region. The object is, for example, a subject such as a person. The object may be an identification person (such as a player, a coach, and/or a referee), or may be an object with a predetermined image pattern, such as a ball or goal post. A moving object may be detected as the object. Processing is performed on the captured image after separating the foreground image including important objects, such as a person, from the background region including no such objects, so that the quality of the image of the portion corresponding to the object of the virtual viewpoint image generated in the image processing system 100 can be improved. Each of the plurality of camera adapters 120 separates the foreground image and the background image, thereby making it possible to disperse the load on the image processing system 100 including the plurality of cameras 112. The predetermined region is not limited to the foreground image, but instead may be, for example, the background image.

A data selection processing unit 6132 measures the data amount of each of the foreground image and the background image which are separated by the foreground/background separating unit 6131. The data selection processing unit 6132 determines whether the sum of the measured data amount and the amount of data transmitted from the network 170 connected at the upstream side of the camera adapter 120 to which the data selection processing unit 6132 belongs exceeds a predetermined data amount. The amount of data transmitted from the network at the upstream side of the camera adapter 120 to which the data selection processing unit 6132 belongs is notified from the bandwidth monitoring unit 6123.

As a result of the determination, when the data amount exceeds the predetermined data amount, the data selection processing unit 6132 limits the data amount to the predetermined data amount or less. Accordingly, the data selection processing unit 6132 first selects data to be transmitted from the foreground image and the background image which are separated by the foreground/background separating unit 6131. Further, the data selection processing unit 6132 transmits the selected data to the transmission unit 6120 and also transmits data which has not been transmitted to a storage unit 6133. On the other hand, when the data amount does not exceed the predetermined data amount, a data selection processing unit 6132 reads data stored in the storage unit 6133, and transmits the read data to the transmission unit 6120. The processing of the data selection processing unit 6132 will be described in detail below.

The external device control unit 6140 has a function of controlling each device connected to the camera adapter 120, and includes the following functional units.

The camera control unit 6141 is connected to the camera 112 and has a function of, for example, controlling the camera 112, acquiring image data obtained by the camera 112, providing a synchronization signal, and setting a time.

The control of the camera 112 includes, for example, setting and referring to shooting parameters (setting of the number of pixels, color depth, frame rate, white balance, etc.). The control of the camera 112 also includes acquisition of the state (during image capturing, during suspension, during synchronization, and error, etc.) of the camera 112, starting and stopping image capturing, and focus adjustment.

The provision of the synchronization signal is performed by providing the camera 112 with an image capturing timing (control clock) by using the time synchronized with the time server 290 that is obtained by the time synchronization control unit 6121.

Setting of the time is performed by providing the time synchronized with the time server 290, which is obtained by the time synchronization control unit 6121, as a time code based on, for example, a SMPTE12M format. Thus, the time code provided from the camera control unit 6141 is appended to the image data received from the camera 112. The format of the time code is not limited to SMPTE12M and other formats may also be used. The camera control unit 6141 may append the time code to the image data received from the camera 112, instead of providing the time code to the camera 112.

A microphone control unit 6142 is connected to the microphone 111 and has a function of, for example, controlling the microphone 111, starting and stopping the sound collection by the microphone 111, and acquiring audio data obtained by the microphone 111.

A pan head control unit 6143 is connected to the pan head 113 and has a function of controlling the pan head 113. The control of the pan head 113 includes, for example, pan/tilt control and acquisition of the state of the pan head 113.

In the image processing system 100 according to the present exemplary embodiment, the foreground image and the background image are transmitted among the plurality of camera adapters 120, which are connected to each other with a daisy chain, and are input to the front-end server 230. In this case, when the area of the foreground region in the captured image is extremely large, a huge amount of data on the foreground image is transmitted.

An example in which the image processing system 100 according to the present exemplary embodiment is installed in a soccer stadium will be described with reference to FIG. 3. Referring to FIG. 3, the network 170 that connects the camera adapters 120 with a daisy chain is divided into two systems of networks 170A and 170B. The cameras 112 corresponding to the camera adapters 120 connected to the respective networks 170A and 170B are installed to capture an image of a region-of-interest 3010A or a region-of-interest 3010B so as to cover the area in front of each goal post. In the example illustrated in FIG. 3, each of the region-of-interest 3010A and the region-of-interest 3010B has one image processing system 100 installed therein. One of the characteristics of an organized sport, such as football, is that a large number of players are located at a place where a ball 3020 is present. Accordingly, in the sensor system 110 in which images of the region-of-interest 3010A located at the place where the ball 3020 is present are captured, the number of objects of the foreground image increases and thus the amount of data to be transmitted increases. On the other hand, the number of players located at the place where the ball 3020 is not present is small. Thus, in the sensor system 110 in which images of the region-of-interest 3010B in which the ball is not present are captured, the number of objects of the foreground image decreases and thus the amount of data to be transmitted decreases. When the number of players in the region-of-interest increases, the amount of data output from the sensor system 110 that captures images of the region-of-interest increases. Accordingly, when the sensor system 110 directly transmits data, the communication band is saturated with the data transmitted from the upstream side in the sensor system 110 which is connected at a downstream side of the network 170 that is connected with a daisy chain, so that data cannot be transmitted.

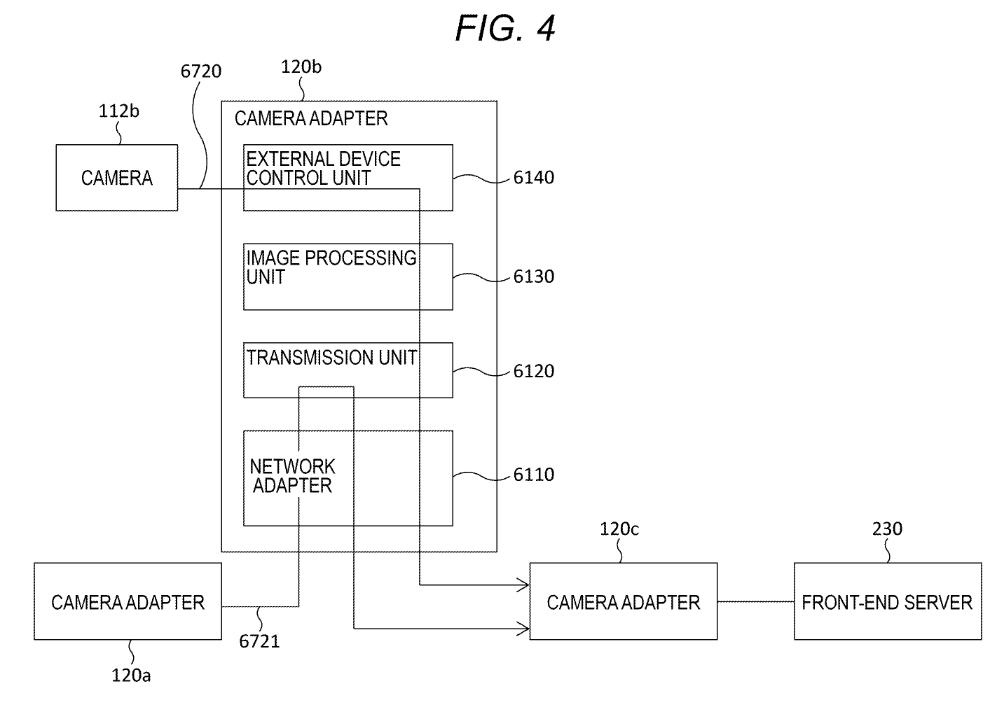

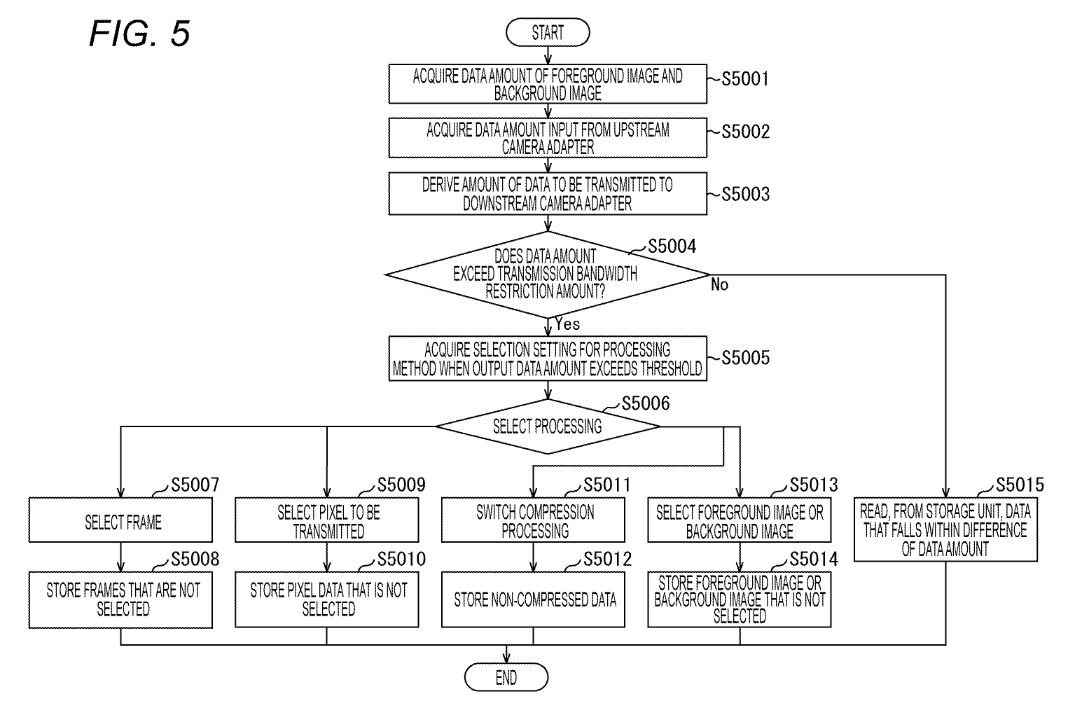

Accordingly, in the present exemplary embodiment, when a large number of players are located in the region-of-interest and the amount of data output from the sensor system 110 increases, the amount of data to be transmitted in the daisy chain is prevented from exceeding a preliminarily set transmission bandwidth. For example, an available bandwidth for transmission is allocated to each sensor system 110, thereby preventing the data amount from exceeding the preliminarily set transmission bandwidth. An example of such a method will be described with reference to FIGS. 4 and 5.

FIG. 4 is a diagram illustrating an example of the flow of data among camera adapters 120a, 120b, and 120c. The camera adapter 120a and the camera adapter 120b are connected to each other, and the camera adapter 120b and the camera adapter 120c are connected to each other. The camera 112b is connected to the camera adapter 120b, and the camera adapter 120c and the front-end server 230 are connected to each other. An example of data output processing of the image processing unit 6130 of the camera adapter 120b will be described below.

The transmission unit 6120 of the camera adapter 120b receives the data which is obtained after image processing is performed, by the image processing unit 6130, on image data 6720 obtained by the camera 112b and whose data amount is adjusted, and also receives data 6721 transmitted from the camera adapter 120a. The transmission unit 6120 receives meta information including the time code for the image data 6720. The transmission unit 6120 performs processing, such as packetization, on the received image data and meta information, and outputs the processed data to the network adapter 6110.

The image data 6720 obtained by the camera 112b illustrated in FIG. 4 is an example of data including an image of a subject included in images captured by an image pickup apparatus connected to the information processing apparatus. For example, an example of the information processing apparatus that is located immediately before the information processing apparatus in a predetermined order is implemented by the camera adapter 120a. An example of data including an image of a subject transmitted from the information processing apparatus that is located immediately before the information processing apparatus in the predetermined order is implemented by, for example, the data 6721 transmitted from the camera adapter 120a. Further, an example of the information processing apparatus that is located after the information processing apparatus in the predetermined order is implemented by, for example, the camera adapter 120c.

Next, an example of processing of the data selection processing unit 6132 when data output from the camera adapter 120b is selected will be described with reference to the flowchart of FIG. 5. The flowchart of FIG. 5 is repeatedly executed for each data output from the camera adapter 120b.

The data selection processing unit 6132 acquires the amount of data to be output from the foreground/background separating unit 6131 (S5001). Next, the data selection processing unit 6132 acquires, from the bandwidth monitoring unit 6123, the amount of the data 6721 transmitted from the camera adapter 120a (S5002). Next, the data selection processing unit 6132 derives the amount of data to be output to the camera adapter 120c based on the data amount acquired in steps S5001 and S5002 (S5003).

In the present exemplary embodiment, the data selection processing unit 6132 acquires, in steps S5001 and S5002, the amount of data to be transmitted which includes an image of a subject included in the captured image and which is to be transmitted to an external device. The data to be transmitted is, for example, data output from the foreground/background separating unit 6131 and the data 6721 transmitted from the camera adapter 120a.

Next, the data selection processing unit 6132 compares the data amount derived in step S5003 with a preliminarily designated transmission bandwidth restriction amount and confirms the possibility of transmission. Specifically, the data selection processing unit 6132 determines whether the amount of data to be output to the transmission unit 6120 exceeds the preliminarily designated transmission bandwidth restriction amount (S5004). A comparison between the data amount derived in step S5003 and the preliminarily designated transmission bandwidth restriction amount may be performed for each type of data (in this case, for example, a foreground image and a background image).

In the present exemplary embodiment, the data selection processing unit 6132 determines whether the amount of the data to be transmitted exceeds a threshold in step S5004. A case where the determination result indicates “Yes” in step S5004 is an example of the case where the amount of the data to be transmitted exceeds the threshold. A case where the determination result indicates “No” in step S5004 is an example of the case where the amount of the data to be transmitted does not exceed the threshold. An example of the threshold is implemented by, for example, the transmission bandwidth restriction amount.

As a result of the determination in step S5004, if the data amount derived in step S5003 exceeds the preliminarily designated transmission bandwidth restriction amount (Yes in step S5004), the data selection processing unit 6132 acquires a setting for selecting a processing method when the amount of output data exceeds the threshold (S5005). This selection setting may be set from the controller 300. The selection setting may be determined for each type of the target end user terminal 190 or for each type of games. For example, when the type of the end user terminal 190 is determined is a type with a low resolution, processing for decreasing the resolution is determined as the selection setting. The data selection processing unit 6132 selects any one of the following processes based on the selection setting for the processing method when the amount of output data acquired in step S5005 exceeds the threshold (S5006).

When the selection setting indicates a setting for decreasing a frame rate, the data selection processing unit 6132 performs processing for decreasing the frame rate for outputting image data and outputting the image data to the transmission unit 6120 (S5007). In other words, the data selection processing unit 6132 adjusts an amount of data to be transmitted by decreasing the frame rate. In this processing, data is transmitted after frames including the foreground image and the background image are thinned out, which leads to a reduction in the data amount. The transmission unit 6120 transmits the data processed in step S5007 through the network adapter 6110. The data selection processing unit 6132 stores, in the storage unit 6133, the data in which frames are thinned out, together with meta information (S5008).

When the selection setting indicates a setting for decreasing a resolution, the data selection processing unit 6132 performs processing for decreasing the resolution of image data and outputting the image data to the transmission unit 6120 (S5009). In other words, the data selection processing unit 6132 adjusts an amount of data to be transmitted by decreasing the resolution. The transmission unit 6120 transmits the data processed in step S5009 through the network adapter 6110. The data selection processing unit 6132 stores, in the storage unit 6133, the difference between the image data obtained before the resolution thereof is decreased and the image data obtained after the resolution thereof is decreased, together with meta information (S5010).

When the selection setting indicates a setting for performing compression processing, the data selection processing unit 6132 performs processing for performing compression processing on image data and outputting the image data to the transmission unit 6120 (S5011). In other words, the data selection processing unit 6132 adjusts an amount of data to be transmitted by selecting a compression method. The transmission unit 6120 transmits the data processed in step S5011 through the network adapter 6110. The data selection processing unit 6132 generally performs lossless compression to reduce the amount of image data. However, if the data amount derived in step S5003 exceeds the preliminarily designated transmission bandwidth restriction amount, the processing is switched to lossy compression to increase a compression rate, thereby reducing the data amount. When the lossy compression is carried out, the data selection processing unit 6132 sores, in the storage unit 6133, information (e.g., a non-compressed image) for restoring the image into the original image, together with meta information (S5012). The information for restoring the image into the original image is not limited to this information, but instead information obtained by encoding data for correcting a degradation as a result of performing the lossy compression may be used. The data selection processing unit 6132 may store the image subjected to lossless compression in the storage unit 6133.

When the selection setting indicates a setting for selecting image data with a high degree of importance, the data selection processing unit 6132 performs the following processing. That is, the data selection processing unit 6132 selects at least one of the foreground image and the background image to be transmitted depending on the degree of importance of the foreground image and the background image, and outputs the selected image together with meta information to the transmission unit 6120 (S5013). In other words, the data selection processing unit 6132 adjusts an amount of data to be transmitted by selecting image data to be transmitted. The transmission unit 6120 transmits the data processed in step S5013 through the network adapter 6110. The data selection processing unit 6132 stores, in the storage unit 6133, image data about the foreground image or the background image that is not selected in step S5013, together with meta information (S5014).

In the present exemplary embodiment, the data selection processing unit 6132 adjusts the data to be transmitted in steps S5007, S5009, S5011, and S5013. In steps S5007, S5009, and S5013, data to be transmitted to the external device is selected from the data to be transmitted. For example, steps S5007, S5009, and S5013 are examples of selecting data to be transmitted to the external device from the data to be transmitted per frame, per pixel, and per region determined based on the object, respectively. The region determined based on the object corresponds to, for example, the region of the foreground image and the background image. For example, step S5011 is an example of compressing the data to be transmitted. In the present exemplary embodiment, the data selection processing unit 613 stores data for bringing the data to be transmitted closer to the adjusted data to be transmitted in steps S5008, S5010, S5012, and S5014.

The processing of the data selection processing unit 6132 and the data stored in the storage unit 6133 are not limited to the examples described above. For example, the data selection processing unit 6132 may perform selection processing for setting the amount of data to be transmitted within a threshold N of the preliminarily designated data amount, and may store, in the storage unit 6133, data that can be restored to the original data obtained before the transmitted data is selected, or data that can be restored as much as possible, together with meta information. The data selection processing unit 6132 may store, in the storage unit 6133, all the original data if it is impossible to restore the data using the transmitted data.

On the other hand, when the data amount derived in step S5003 does not exceed the preliminarily designated transmission bandwidth restriction amount (No in step S5004), the data selection processing unit 6132 performs the following processing. That is, the data selection processing unit 6132 reads, from the storage unit 6133, data that falls within the difference between the data amount derived in step S5003 and the preliminarily designated transmission bandwidth restriction amount (S5015). The data selection processing unit 6132 outputs the read data to the transmission unit 6120. The transmission unit 6120 transmits the data read in step S5015 and the data that does not exceed the transmission bandwidth restriction amount (data corresponding to the data amount obtained in steps S5001 and S5002) through the network adapter 6110.

In the present exemplary embodiment, for example, the transmission unit 6120 and the network adapter 6110 transmit, in step S5015, the adjusted data to be transmitted and then transmits data for bringing the adjusted data to be transmitted close to the data to be transmitted.

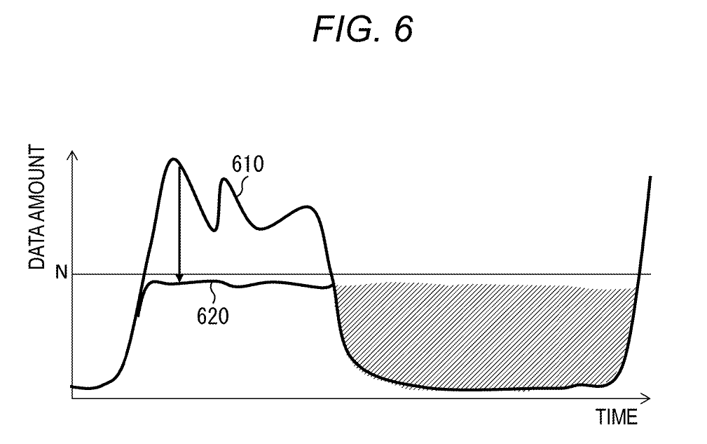

FIG. 6 is a graph illustrating a time change of a data amount. Specifically, FIG. 6 is a diagram illustrating an example of a time change of the value obtained by adding the amount of data output from the foreground/background separating unit 6131 and the amount of data transmitted from the upstream of the network. In FIG. 6, the preliminarily designated transmission bandwidth restriction amount is represented by N. The transmission bandwidth restriction amount N in each camera adapter 120 can be set to, for example, the following value. That is, the transmission bandwidth restriction amount N can be set to the value obtained by multiplying the value obtained by dividing the amount of data transmitted in the daisy chain by the number of sensor systems 110 installed in the image processing system 100 by the number of sensor systems 110, which are connected at the upstream side of the daisy chain, +1. In this case, however, the transmission bandwidth restriction amount N in each camera adapter 120 is not limited to this value. The amount of data transmitted in the daisy chain refers to a predetermined amount of data that can be transmitted to the network. For example, the amount of data transmitted in the daisy chain is a maximum amount of data that can be transmitted to the network.

In the case where the amount of data output from each camera adapter 120 exceeds the preliminarily designated transmission bandwidth restriction amount N, if the data is output directly, it is highly likely that the communication band may be saturated at the downstream side of the daisy chain. As a result, data cannot be transmitted in the sensor system 110 connected at the downstream side of the network. Therefore, the data selection processing unit 6132 selects data to be output so that the amount of data output from the camera adapter 120 to which the data selection processing unit 6132 belongs falls within the transmission bandwidth restriction amount N. Thus, the data output from the data selection processing unit 6132 to the transmission unit 6120 is reduced from data 610 to data 620. The data selection processing unit 6132 stores, in the storage unit 6133, data that has not been output from the camera adapter 120 to which the data selection processing unit 6132 belongs. When the data selection processing unit 6132 determines that the amount of data to be output does not exceed the preliminarily designated transmission bandwidth restriction amount N, data is read from the storage unit 6133 using the available bandwidth (indicated by a hatched area in FIG. 6), and the data is also transmitted.

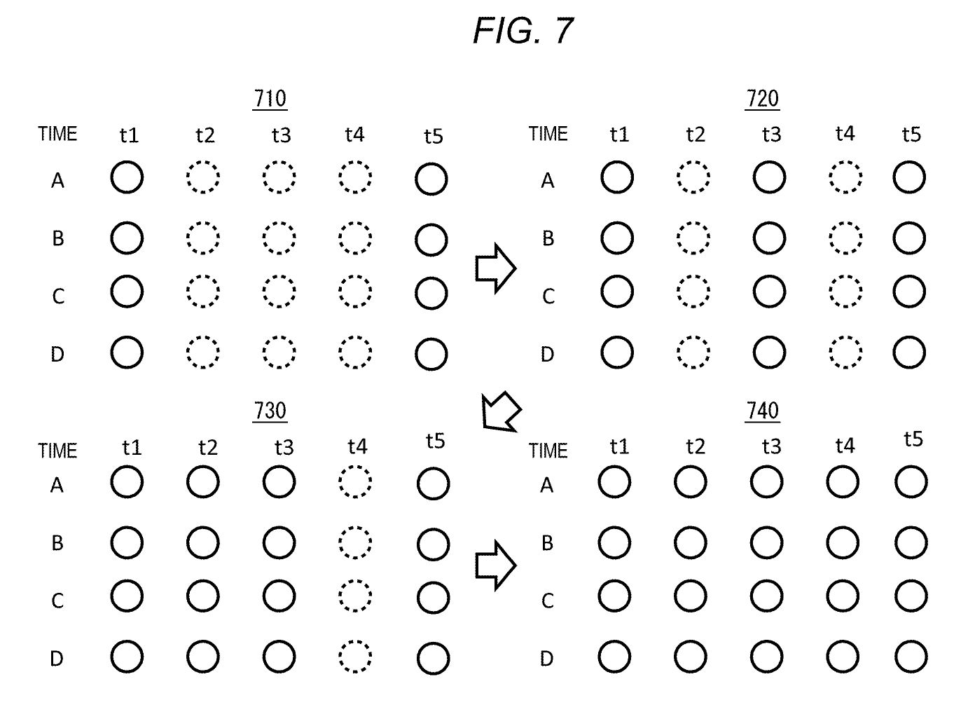

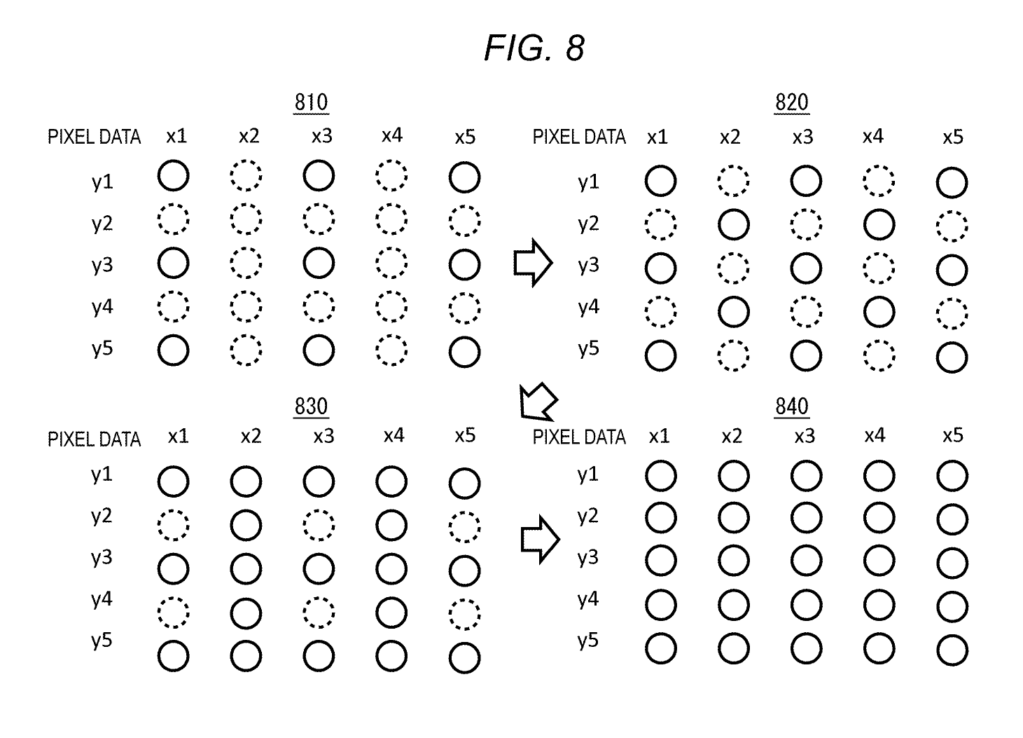

Referring next to FIGS. 7 and 8, a change of the data to be transmitted to the database 250 as a result of the data selection processing described above, along with a time lapse, will be described.

Referring first to FIG. 7, an example of the change of the data to be transmitted to the database 250 will be described by illustrating a case where when the data derived by the data selection processing unit 6132 exceeds the preliminarily designated transmission bandwidth restriction amount N, the data is transmitted after decreasing the frame rate to one-fourth the original amount of data. This description relates to processing to be performed in step S5006 illustrated in FIG. 5 when the processing of steps S5007 is selected. In FIG. 7, each of A, B, C, and D represents the sensor system 110 and each of t1, t2, t3, t4, and t5 represents time. Each circle represents data of a frame captured by the camera 112 at times t1 to t5.

The data selection processing unit 6132 determines that the amount of data to be output to the transmission unit 6120 exceeds the transmission bandwidth restriction amount N (see “Yes” in step S5004) when images are captured by the camera 112 connected to the camera adapter 120 to which the data selection processing unit 6132 belongs. Further, the data selection processing unit 6132 selects frame data represented by a solid circle in a state 710 illustrated in FIG. 7 (S5007), and outputs the selected frame data to the transmission unit 6120. The data selection processing unit 6132 stores, in the storage unit 6133, the frame data represented by a dashed circle in the state 710 illustrated in FIG. 7 (S5008). As a result, the amount of data to be output from the data selection processing unit 6132 to the transmission unit 6120 is reduced to one-fourth the amount of data to be originally output from the data selection processing unit 6132 to the transmission unit 6120.

After that, when the data selection processing unit 6132 determines that the amount of data to be output to the transmission unit 6120 does not exceed the transmission bandwidth restriction amount N (No in step S5004), the data selection processing unit 6132 reads the frame data that is indicated by a dashed circle and stored in the storage unit 6133 (S5015). The data selection processing unit 6132 outputs, to the transmission unit 6120, the read frame data in addition to the data output from the foreground/background separating unit 6131. As a result, the amount of frame data (frame data represented by a solid circle) transmitted from the transmission unit 6120 gradually increases with a lapse of time (see state 710→state 720→state 730→state 740 illustrated in FIG. 7). Finally, all frame data are transmitted from the transmission unit 6120. In practice, the time required for completing the transmission of frame data transmitted when the transmission bandwidth is available varies among the sensor systems 110. In the example illustrated in FIG. 7, the data selection processing unit 6132 selects frame data to be output to the transmission unit 6120 in the order of frame data at times t1 and t5→frame data at t3→frame data at t2→frame data at t4. Thus, in the middle of transmission of frame data, the already transmitted frames can be made as even as possible.

In the database 250, information indicating whether the reception of frame data of one frame from each sensor system 110 at each time is completed, and information indicating whether the frame data for all sensor systems 110 at the time is received are managed using the state management table. The database 250 determines whether to provide the frame data in accordance with the state management table in response to a frame data request from the back-end server 270. Accordingly, the virtual viewpoint image generated in the back-end server 270 is an image with a frame rate of 15 fps immediately after image capturing. With a lapse of time, sufficient data is obtained and the frame rate gradually increases, and finally the virtual viewpoint image with a frame rate of 60 fps is obtained.

Referring next to FIG. 8, an example of a change of data to be transmitted to the database 250 will be described by illustrating a case where data is transmitted after the resolution thereof is halved lengthwise and crosswise because the data derived by the data selection processing unit 6132 exceeds the preliminarily designated transmission bandwidth restriction amount N. This description relates to processing to be performed in step S5006 illustrated in FIG. 5 when processing of step S5009 is selected. In FIG. 8, x1 to x5 each represent an x-coordinate of a pixel; y1 to y5 each represent a y-coordinate of a pixel; and each circle represents pixel data at each coordinate.

The data selection processing unit 6132 determines that the amount of data to be output to the transmission unit 6120 exceeds the transmission bandwidth restriction amount N (see “Yes” in step S5004) when images are captured by the camera 112 connected to the camera adapter 120 to which the data selection processing unit 6132 belongs. The data selection processing unit 6132 selects pixel data represented by a solid circle in a state 810 illustrated in FIG. 8 (S5009), and outputs the selected pixel data to the transmission unit 6120. The data selection processing unit 6132 stores, in the storage unit 6133, pixel data represented by a dashed circle in the state 810 illustrated in FIG. 8 (S5010). As a result, the amount of data to be output from the data selection processing unit 6132 to the transmission unit 6120 is reduced to one-fourth the amount of data to be originally output from the data selection processing unit 6132 to the transmission unit 6120.

After that, when the data selection processing unit 6132 determines that the amount of data to be output to the transmission unit 6120 does not exceed the transmission bandwidth restriction amount N (No in step S5004), the data selection processing unit 6132 reads pixel data that is represented by a dashed circle and stored in the storage unit 6133 (S5015). Further, the data selection processing unit 6132 outputs the read pixel data, to the transmission unit 6120, in addition to the data output from the foreground/background separating unit 6131. As a result, the amount of pixel data (pixel data represented by a solid circle) transmitted from the transmission unit 6120 gradually increases with a lapse of time (see state 810→state 820→state 830→state 840 illustrated in FIG. 8). Finally, all pixel data are transmitted from the transmission unit 6120. In practice, the time required for completing the transmission of frame data transmitted when the transmission bandwidth is available varies among the sensor systems 110. In the example illustrated in FIG. 8, the data selection processing unit 6132 selects pixel data to be output to the transmission unit 6120 in the order of pixel data in odd column/odd row→pixel data in even column/even row→pixel data in even column/odd row→pixel data in odd column/even row. Thus, in the middle of transmission of pixel data, the already transmitted pixels can be made as even as possible.

In the database 250, the reception status of pixel data in each frame from each sensor system 110 is managed using the state management table. In response to a frame data request from the back-end server 270, if the pixel data is incomplete in the database 250, required pixels are supplemented in accordance with the state management table to thereby provide the pixel data. Accordingly, the resolution of the virtual viewpoint image generated by the back-end server 270 is halved lengthwise and crosswise immediately after image capturing. With a lapse of time, sufficient data is obtained and the resolution gradually increases, and finally the virtual viewpoint image with the original resolution is obtained.

To facilitate the explanation, FIGS. 7 and 8 illustrate a case where the amount of data is reduced to one-fourth the original amount of data. However, the amount of data to be reduced is determined depending on how much the amount of data to be output to the transmission unit 6120 exceeds the transmission bandwidth restriction amount N (data amount that can be transmitted by the camera adapter 120).

In the present exemplary embodiment, the network 170 connected with a daisy chain is illustrated by way of example. However, the connection form of the camera adapter 120 is not limited to the daisy chain connection. For example, the present disclosure can also be applied to a case where it is necessary to limit the amount of data to be output from each sensor system 110 in a star network. For example, assume a case where there is an upper limit of the bandwidth of data to be input from the network of the front-end server 230, a case where there is an upper limit of the bandwidth of data to be input using the database 250, or the like. In this case, the method according to the present exemplary embodiment can also be applied, like in the case of the daisy chain connection described above, except that the need for the bandwidth monitoring unit 6123 to monitor the amount of data from the upstream side is eliminated.

The present exemplary embodiment is described assuming that the capacity of the storage unit 6133 is sufficient. However, a storage unit with a certain capacity needs to be used as the storage unit 6133 in some cases. In such cases, the data selection processing unit 6132 needs to store new image data after deleting the content of the storage unit 6133. Accordingly, the data selection processing unit 6132 sequentially deletes contents from, for example, the content with the oldest time code. However, the method for storing necessary data in the storage unit 6133 when there is a restriction on the capacity is not limited to this method. For example, the data selection processing unit 6132 may determine the data to be deleted from the storage unit 6133 based on the degree of importance of data within a screen by, for example, deleting data from the background image.

As described above, in the present exemplary embodiment, when there is a restriction on the communication band and it is necessary to select data to be transmitted, the data selection processing unit 6132 determines that the selected data is transmitted and non-selected data is stored in the storage unit 6133. After that, when the communication band is available, the data selection processing unit 6132 transmits data stored in the storage unit 6133. Accordingly, in the case of generating a virtual viewpoint image, it is possible to prevent the communication band for transmitting images captured by each camera 112 from being insufficient or from being compressed. Virtual viewpoint images with a higher image quality can be generated gradually with a lapse of time.

The present exemplary embodiment illustrates a case where the processing method is selected when the amount of data to be output from the camera adapter 120 exceeds the preliminarily designated transmission bandwidth restriction amount N. The processing method is not limited to the method described above. There is no need to use all the processing of steps S5007 to S5008, S5009 to S5010, S5011 to S5012, and S5013 to S5014 illustrated in FIG. 5 as options, but instead any one of the processing may be carried out. The processing is not limited to these examples.

### Second Exemplary Embodiment

Next, a second exemplary embodiment will be described. The first exemplary embodiment illustrates an example in which the communication band is monitored for each sensor system 110 and data to be transmitted is determined when the communication band for transmission is available. However, if the communication band is not available for the capacity of data stored in the storage unit 6133, a priority order of data to be transmitted may be instructed to transmit data in order from data with a highest priority level. The present exemplary embodiment illustrates such a case. In this manner, the present exemplary embodiment differs from the first exemplary embodiment mainly in terms of processing to be performed when the data selection processing unit 6132 determines that the amount of data to be output to the transmission unit 6120 does not exceed the transmission bandwidth restriction amount N (No in S5004). Accordingly, in the description of the present exemplary embodiment, the same parts as those of the first exemplary embodiment are denoted by the same reference numerals as those given in FIGS. 1 to 8 and detailed descriptions thereof are omitted.

An example of the configuration of the image processing system according to the present exemplary embodiment is similar to the configuration illustrated in FIG. 1. The controller 300 selects and determines a scene that is determined by an operator to be important, and automatically analyzes images to determine the scene that is determined to be important. The important scene described herein refers to, for example, a scene which the user wishes to view, such as a goal-scoring scene or a ball shooting scene, when the image processing system is applied to a soccer stadium. In the present exemplary embodiment, a case where a scene is designated with a time code (starting time and end time) during image capturing is illustrated by way of example.

Scene information determined in this manner by the controller 300 is sent to the data selection processing unit 6132 within the sensor system 110 via the networks 310a, 180a, and 170.

In the present exemplary embodiment, the data selection processing unit 6132 acquires the scene information.

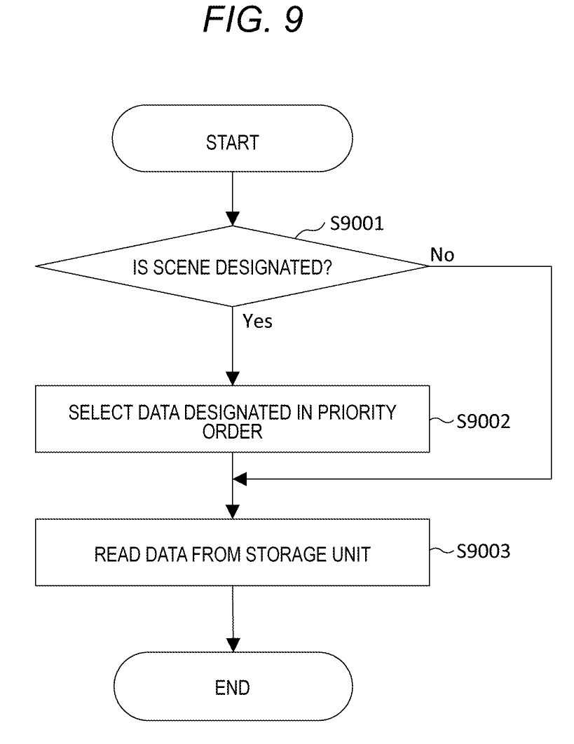

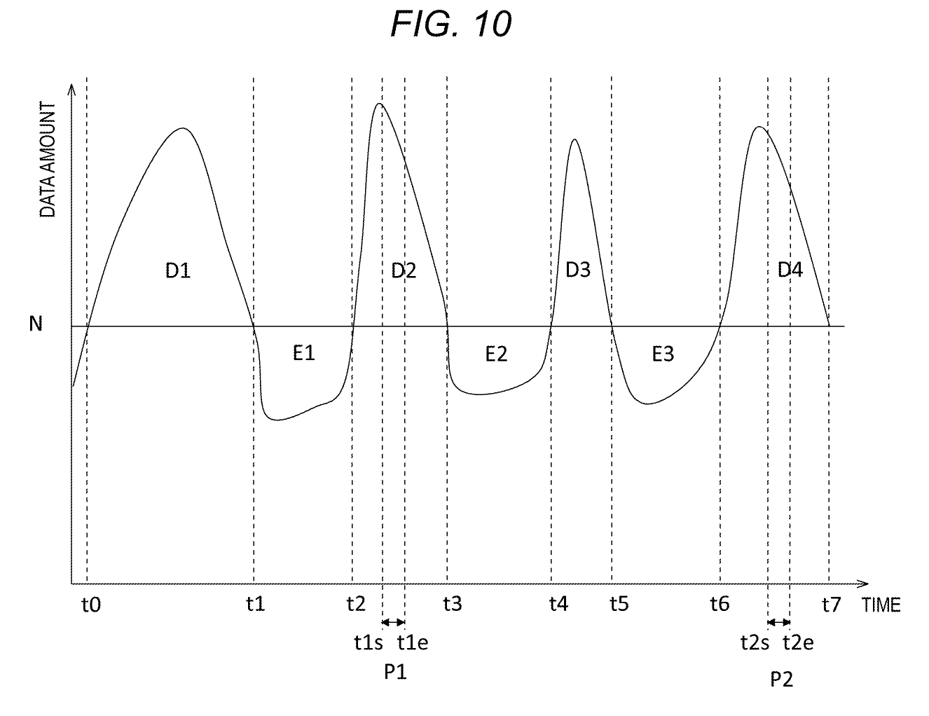

Next, an example of processing (processing of step S5015 illustrated in FIG. 5) of the data selection processing unit 6132 when the data communication band is available will be described with reference to FIGS. 9 and 10. FIG. 9 is a flowchart illustrating an example of processing of step S5015 illustrated in FIG. 5. FIG. 10 illustrates an example of a time change of a data amount. Specifically, FIG. 10 is a diagram illustrating an example of a time change of the value obtained by adding the amount of data to be output from the foreground/background separating unit 6131 to the amount of data to be transmitted from the upstream side of the network. In FIG. 10, the preliminarily designated transmission bandwidth restriction amount is represented by N.

When the data amount exceeds the transmission bandwidth restriction amount N, the data selection processing unit 6132 performs data selection processing, and data that has not been selected in the selection processing is stored in the storage unit 6133. In FIG. 10, periods stored in the storage unit 6133 are represented by D1 to D4 and period in which the data communication band is sufficiently large are represented by E1 to E3. The controller 300 designates the following two pieces of scene information as scene information for identifying an important scene. First, the controller 300 designates scene information P1. The scene information P1 includes a starting time t1s and an end time t1e of a first important scene. Further, the controller 300 designates scene information P2. The scene information P2 includes a starting time t2s and an end time t2e of the subsequent important scene.

In the periods D1 (time t0 to time t1), D2 (time t2 to time t3), D3 (time t4 to time t5), and D4 (time t6 to time t7), the data amount exceeds the transmission bandwidth restriction amount N. Accordingly, in steps S5008, S5010, S5012, and S5014, the data selection processing unit 6132 stores data with time information in the storage unit 6133. Next, in the period E1 (time t1 to time t2) in which the data amount is less than the transmission bandwidth restriction amount N, the scene information is not indicated from the controller 300. Accordingly, the data selection processing unit 6132 determines that the scene information is not indicated from the controller 300 (the determination result in step S9001 illustrated in FIG. 9 indicates “No”). Therefore, the data selection processing unit 6132 reads the data stored in the period D1 from the storage unit 6133 and transmits the data (see step S9003 in FIG. 9). Since the amount of data that can be transmitted in the period E1 is less than the amount of data stored in the period D1, the data stored in the period D1 still remains in the storage unit 6133 at time t2. Next, in the period D2 (time t2 to time t3), the data amount exceeds the transmission bandwidth restriction amount N again. Accordingly, the data selection processing unit 6132 stores data with time information in the storage unit 6133. In this case, scene information (starting time: t1s, end time: t1e, scene information P1) to be transmitted is notified from the controller 300.

When the data amount is less than the transmission bandwidth restriction amount N at time t3 (when the determination result in step S5004 indicates “No”), the data selection processing unit 6132 determines that the scene information is indicated (the determination result in step S9001 illustrated in FIG. 9 indicates “Yes”). Accordingly, the data selection processing unit 6132 reads the data indicated in the scene information from the storage unit 6133, instead of reading the data stored in the period D1, in the order (i.e., in chronological order) of data stored in the storage unit 6133 (steps S9002 and S9003 in FIG. 9). Specifically, data stored during the period from time t1s to time t1e is read from the storage unit 6133. In the present exemplary embodiment, the data selection processing unit 6132 selects data identified by data identifying information from the stored data in step S9002.

After reading of the data indicated in the scene information is completed, the data selection processing unit 6132 reads the data stored in the storage unit 6133 again in the chronological order of data stored in the storage unit 6133. Also, at time t7, like at time t3, the data selection processing unit 6132 determines that the data amount is less than the transmission bandwidth restriction amount N (the determination result in step S5004 indicates “No”). In this case, the data selection processing unit 6132 reads the data indicated in the scene information (data obtained during the period from time t2s to time t2e) from the storage unit 6133 (steps S9002 and S9003 in FIG. 9).

As described above, in the present exemplary embodiment, when the data communication band is available, the data selection processing unit 6132 selects data on the scene designated from the controller 300, and outputs the selected data to the transmission unit 6120. Accordingly, in addition to the advantageous effects described in the first exemplary embodiment, the virtual viewpoint image of the scene with a higher priority level can be generated with a less delay.

In the present exemplary embodiment, the case where a scene is designated with a time code (starting time and end time) during image capturing has been described by way of example. However, the method for designating a scene is not limited to this method, and any method can be used as long as a scene can be identified. For example, the controller 300 may designate a frame number. The controller 300 can add information about a priority level (priority order) to each scene identified by scene information for identifying an important scene so that scenes with higher degree of importance can be transmitted. In addition, also in the present exemplary embodiment, various modified examples described in the first exemplary embodiment can be employed. In the present exemplary embodiment, for example, an example of time information with which data is obtained is implemented by using a time code during image capturing, and an example of identification information for identifying data is implemented by using a frame number. For example, an example of information for identifying a plurality of pieces of data is implemented by using the scene information P1 and P2. Further, for example, an example of information indicating a priority order for stored data is implemented by using information about a priority level (priority order) added to each scene identified by scene information.

The exemplary embodiments described above merely illustrate specific examples for carrying out the present disclosure, and the technical scope of the present disclosure should not be narrowly interpreted by the exemplary embodiments. That is, the present disclosure can be carried out in various ways without departing from the technical idea of the disclosure or the principal features of the disclosure.

### Other Exemplary Embodiments

The present disclosure can also be implemented by processing in which a program for implementing one or more functions according to the exemplary embodiments described above is supplied to a system or apparatus via a network or storage medium and one or more processors in a computer of the system or apparatus read and execute the program. The present disclosure can also be implemented by a circuit (e.g., an application specific integrated circuit (ASIC)) that implements one or more functions according to the exemplary embodiments.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, the scope of the following claims are to be accorded the broadest interpretation so as to encompass all such modifications and equivalent structures and functions.

This application claims the benefit of Japanese Patent Application No. 2017-094856, filed May 11, 2017, which is hereby incorporated by reference herein in its entirety.

What is claimed is:

1. A transmission device that transmits data via a network, the transmission device comprising:
an adjusting unit configured to adjust an amount of data to be transmitted to be equal to or less than a threshold by decreasing a quality of an image, when the amount of data to be transmitted exceeds the threshold, the data to be transmitted including the image; and
a transmission unit configured to transmit data for improving the quality of the image via the network after the data to be transmitted is transmitted, the amount of the data to be transmitted being adjusted by the adjusting unit.

2. The transmission device according to claim 1, further comprising a processing unit configured to process a captured image,
wherein the data to be transmitted includes data processed by the processing unit and data received from an external device.

3. The transmission device according to claim 1, wherein the transmission unit transmits, to the network, the data for improving the quality of the image when an available bandwidth for transmission is present in the network.

4. The transmission device according to claim 1, wherein the transmission unit transmits data for restoring the data to be transmitted into the original data to be transmitted, the data to be transmitted being adjusted by the adjusting unit.

5. The transmission device according to claim 1, wherein the adjusting unit selects data to be transmitted to the network from the data to be transmitted.

6. The transmission device according to claim 1, wherein the adjusting unit selects data to be transmitted to the network from the data to be transmitted for each region determined based on one of a frame, a pixel, and an object.

7. The transmission device according to claim 5, wherein the transmission unit transmits data that is not selected by the adjusting unit from among the data to be transmitted as the data for improving the quality of the image.

8. The transmission device according to claim 1, wherein the transmission unit compresses the data to be transmitted.

9. The transmission device according to claim 8, wherein the data for improving the quality of the image is one of the data to be transmitted that is compressed at a compression rate lower than a compression rate for performing compression by the adjusting unit, and the data to be transmitted that is not compressed by the adjusting unit.

10. The transmission device according to claim 1, further comprising:
a storage unit configured to store, in a storage medium, data for bringing the data to be transmitted close to the original data to be transmitted, the data to be transmitted being adjusted by the adjusting unit;
an acquisition unit configured to acquire data identifying information as information for identifying data stored by the storage unit; and
a selection unit configured to select, from among the data stored by the storage unit, data identified by the data identifying information,
wherein the transmission unit transmits the data selected by the selection unit.

11. The transmission device according to claim 10, wherein the data identifying information includes one of time information indicating a time when data is obtained, and identification information about data.

12. The transmission device according to claim 10, wherein the data identifying information includes information for identifying a plurality of pieces of data.

13. The transmission device according to claim 10, wherein the data identifying information includes information indicating a priority order for the data stored by the storage unit.

14. The transmission device according to claim 1, wherein the transmission device is daisy-chain-connected to another transmission device via the network.

15. The transmission device according to claim 1, wherein the transmission unit transmits, via the network, the data for improving the quality of the image to an external device to generate an image of a subject when the subject is viewed from a set viewpoint by using an image of the subject included in a plurality of images captured from a plurality of directions.

16. A transmission method for transmitting data via a network, the transmission method comprising:
adjusting an amount of data to be transmitted to be equal to or less than a threshold by decreasing a quality of an image, when the amount of data to be transmitted exceeds the threshold, the data to be transmitted including the image; and
transmitting data for improving the quality of the image via the network after the data to be transmitted is transmitted, the amount of the data to be transmitted being adjusted.

17. A storage medium storing instructions for causing a computer to execute a transmission method for transmitting data via a network,
the transmission method comprising:
adjusting an amount of data to be transmitted to be equal to or less than a threshold by decreasing a quality of an image, when the amount of data to be transmitted exceeds the threshold, the data to be transmitted including the image; and
transmitting data for improving the quality of the image via the network after the data to be transmitted is transmitted, the amount of the data to be transmitted being adjusted.
